(19) United States
(12) Patent Application Publication
(10) Pub. No.: US 2026/0163731 A1
(43) Pub. Date: Jun. 11, 2026

(54) INFORMATION PROCESSING DEVICE, INFORMATION PROCESSING METHOD, AND PROGRAM

(71) Applicant: Sony Semiconductor Solutions Corporation, Kanagawa (JP)

(72) Inventor: Shingo Miyajima, Kanagawa (JP)

(21) Appl. No.: 19/123,325

(22) PCT Filed: Sep. 26, 2023
(86) PCT No.: PCT/JP23/34813

§ 371 Date: Apr. 22, 2025

(30) Foreign Application Priority Data
Nov. 7, 2022 (JP) 2022-178262

(51) Int. Cl. H04L 9/14; G06F 21/60; H04L 9/08

(52) U.S. Cl. CPC H04L 9/14; G06F 21/602; H04L 9/0869

(57) ABSTRACT

Information processing that achieves both privacy protection and accident cause investigation is disclosed. In one example, an information processing device includes a processing circuit. The processing circuit sets, for data generated by a sensor mounted on a vehicle, a level based on an elapsed time from generation of the data or a type of the data, and executes encryption processing of the data on the basis of the set level.

### TECHNICAL FIELD The present disclosure relates to an information processing device, an information processing method, and a program.

### BACKGROUND ART

In a case where an automobile accident occurs, the cause may be investigated by referring to a video recorded by a drive recorder, a sensing camera, or the like. The drive recorder, the sensing camera, and the like mainly have a function of recording sensing data acquired by a vehicle-mounted sensor. On the other hand, viewing the sensing data acquired by the vehicle-mounted sensor by others is often problematic from the viewpoint of privacy protection.

By using a signal output from an acceleration sensor, an event such as an impact, a sudden acceleration, or a sudden steering wheel is detected, and recording of video or audio at those timings is left and used for self-verification, thereby conducting research and development of a vehicle-mounted device capable of recording necessary data while paying attention to privacy protection.

However, the technology in which privacy protection for image data is taken into consideration has not been achieved, and there is also a problem that audio data is automatically erased in a case where time elapses from occurrence of an event, and it is still difficult to achieve both privacy protection and investigation of an accident cause.

### CITATION LIST

### Patent Document

Patent Document 1: Japanese Patent Application Laid-Open No. 2022-028858

### SUMMARY OF THE INVENTION

### Problems to be Solved by the Invention

Therefore, one of the non-limiting problems to be solved by the embodiments of the present disclosure is to achieve both privacy protection and investigation of an accident cause. The problem to be solved by the embodiments of the present disclosure can also be a problem corresponding to the effects described in the embodiments as some examples that are not further limited. That is, the problem corresponding to at least one of any of the effects described in the description of the embodiments of the present disclosure can be solved in the present disclosure.

### Solutions to Problems

According to an embodiment, an information processing device includes a processing circuit.

The processing circuit
sets, for data generated by a sensor mounted on a vehicle, a level based on an elapsed time from generation of the data or a type of the data, and
executes encryption processing of the data on the basis of the set level.

A storage section may be further included, and
the processing circuit may store the encrypted data in the storage section.

The processing circuit
may set, to a first level, the data until a first predetermined time elapses after the data is acquired, and
may store the data at the first level in the storage section without being encrypted.

The processing circuit
may set, to a second level, the data until a second predetermined time elapses after the first predetermined time elapses after the data is acquired, and
may encrypt the data at the second level using a first encryption key and store the data in the storage section.

The processing circuit
may set, to a third level, the data until a third predetermined time elapses after the second predetermined time elapses after the data is acquired, and
may encrypt the data at the third level using a second encryption key and store the data in the storage section.

The processing circuit
may perform, when the data set to the second level and encrypted is set to the third level after the second predetermined time elapses, decryption corresponding to the first encryption key and then encrypt the data using the second encryption key.

The processing circuit
may encrypt, after the first predetermined time elapses, the data using a third encryption key, encrypt a key for decrypting the data encrypted using the third encryption key using the first encryption key, and store the encrypted key in association with the data encrypted using the third encryption key, and
may encrypt, after the second predetermined time elapses, a key for decrypting the data encrypted using the third encryption key using the second encryption key, and store the encrypted key in association with the data encrypted using the third encryption key.

The processing circuit
may generate the third encryption key as a random key, and
may update the third encryption key at every predetermined timing.

The processing circuit
after the third predetermined time elapses from acquisition of the data, may discard the data or upload the data to an external server or storage.

The data may include one or a plurality of pieces of frame data.

The data may include data including an image and audio.

The processing circuit
after the first predetermined time elapses from acquisition of the data, may set data of a first type in the data to a second level and set data of a second type in the data to a third level,
may encrypt the data set to the second level using a first encryption key,
may encrypt the data set to the third level using a second encryption key, and
may store each encrypted data in the storage section.

According to an embodiment, electronic equipment includes a vehicle-mounted sensor and the information processing device according to any one of the above.

A processing circuit of the information processing device encrypts and stores data sensed and generated by the vehicle-mounted sensor.

The vehicle-mounted sensor may include an imaging section.

The vehicle-mounted sensor may include a sound collection section.

According to an embodiment, an information processing method includes:
by a processing circuit,
   setting, for data generated by a sensor mounted on a vehicle, a level based on an elapsed time from generation of the data; and
   executing encryption processing of the data on the basis of the set level.

According to an embodiment, a program causes a processing circuit to execute an information processing method including:
setting, for data generated by a sensor mounted on a vehicle, a level based on an elapsed time from generation of the data; and
executing encryption processing of the data on the basis of the set level.

According to an embodiment, an information processing device includes a processing circuit.

The processing circuit
sets, for data generated by a sensor, a level based on an elapsed time from generation of the data or a type of the data, and
executes encryption processing of the data on the basis of the set level.

According to an embodiment, an information processing device includes a first encryption section, a second encryption section, and a data storage section.

The first encryption section encrypts, on the basis of a first encryption key, data after a lapse of a first predetermined time from acquisition of data until a lapse of a second predetermined time.

The second encryption section encrypts, on the basis of a second encryption key, data after a lapse of the second predetermined time from acquisition of data.

The data storage section stores data encrypted by the first encryption section and the second encryption section.

The encryption described in any one of the above may include
encryption that realizes at least one of
   encryption that controls access to data, or
   encryption that prevents falsification of data.

### BRIEF DESCRIPTION OF DRAWINGS

FIG. 1 is a block diagram schematically illustrating an example of electronic equipment according to an embodiment.

FIG. 2 is a flowchart illustrating an example of processing of an information processing device according to an embodiment.

FIG. 3 is a diagram illustrating an example of data storage according to an embodiment.

FIG. 4 is a block diagram schematically illustrating an example of electronic equipment according to an embodiment.

FIG. 5 is a flowchart illustrating an example of processing of an information processing device according to an embodiment.

FIG. 6 is a diagram illustrating an example of data storage according to an embodiment.

FIG. 7 is a flowchart illustrating an example of processing of an information processing device according to an embodiment.

FIG. 8 is a diagram illustrating an example of data storage according to an embodiment.

FIG. 9 is a block diagram illustrating an example of a schematic configuration of a vehicle control system.

FIG. 10 is an explanatory diagram illustrating an example of installation positions of an outside-vehicle information detecting section and an imaging section.

### MODE FOR CARRYING OUT THE INVENTION

The following is a description of embodiments of the present disclosure, with reference to the drawings. The drawings are used for explanation, and the shape and size of each configuration in actual devices, the ratios of size to other configurations, and the like are not necessarily as illustrated in the figure. furthermore, since the drawings are illustrated in a simplified manner, configurations necessary for implementation other than those illustrated in the drawings are appropriately provided.

Furthermore, in the present disclosure, expressions such as “until the time elapses” and “after the time elapses” may be used as an expression representing time, but it is possible to arbitrarily set whether the moment of the time is included in “until the time elapses” or “after the time elapses” depending on the implementation form. That is, “until the lapse” can be read as “before the lapse”, and “after the lapse” can be read as “on and after the lapse”.

### First Embodiment

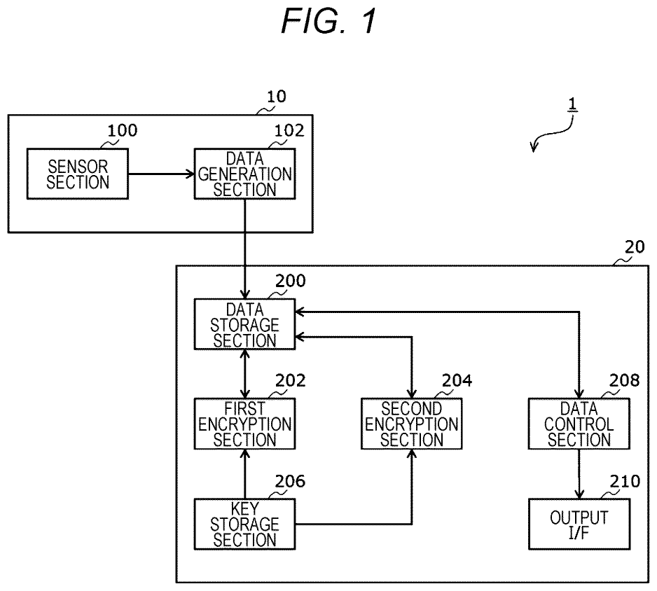

FIG. 1 is a block diagram schematically illustrating electronic equipment 1 according to an embodiment. The electronic equipment 1 is, for example, a device including a sensor mounted on an automobile, and includes a vehicle-mounted sensor 10 and an information processing device 20. The electronic equipment 1 is a device that can protect privacy of a person in the vehicle or the like and output appropriate accident investigation data by encrypting appropriate data.

The vehicle-mounted sensor 10 acquires various information inside and outside the vehicle. The vehicle-mounted sensor 10 includes, for example, a sensor section 100 and a data generation section 102. In addition, although not illustrated, the vehicle-mounted sensor 10 may include a storage section that stores data required for processing or processed, such as sensing data required for data generation and generated data.

The sensor section 100 desirably includes at least an imaging section, for example. The imaging section included in the sensor section 100 acquires optically acquirable information inside and outside the vehicle. Furthermore, the sensor section 100 desirably further includes a sound collection section. The sound collection section included in the sensor section 100 acquires audio information inside and outside the vehicle.

The data generation section 102 converts the information acquired by the sensor section 100 into appropriate information, and generates data that can be confirmed by a human. The data generation section 102 can generate, for example, image data (Hereinafter, a concept including video data will be referred to as image data.) on the basis of information acquired from the imaging section. Furthermore, the data generation section 102 can generate audio data on the basis of the information acquired from the sound collection section, for example. In a case where both the imaging section and the sound collection section are provided, the data generation section 102 may be configured to generate data in which image data generated by data from the imaging section and audio data generated by data from the sound collection section are associated with each other.

The data generation section 102 may be formed by a dedicated analog and/or digital electronic circuit, or may be implemented in a form in which information processing by software is specifically realized using hardware resources in a general-purpose processor or the like. In the case of being implemented by software, a program or an execution file related to the software may be stored in a storage section (not illustrated).

Furthermore, the data generation section 102 may be included in the information processing device 20 described below. In this case, the data acquired by the vehicle-mounted sensor 10 can be transferred to the information processing device 20, and the data can be generated in the information processing device 20.

Furthermore, at least some functions of the vehicle-mounted sensor 10 and the information processing device 20 may be mounted on the same semiconductor substrate. For example, the sensor section 100 may be an upper semiconductor layer, and at least a part of the configuration elements of the data generation section 102 and the information processing device 20 may be a lower semiconductor layer, and the electronic equipment 1 may include a stacked semiconductor layer. These semiconductor layers may be formed separately and joined by an appropriate method. In this case, the sensor section 100 may be provided as a part of the information processing device 20. That is, the information processing device 20 including the vehicle-mounted sensor 10 may be formed as the electronic equipment 1.

The information processing device 20 is a device that appropriately processes and stores information acquired by the sensor. The information processing device 20 includes a data storage section 200, a first encryption section 202, a second encryption section 204, a key storage section 206, a data control section 208, and an output I/F 210.

The information processing device 20 includes, for example, a processing circuit and a storage circuit for implementing the above configuration, and the processing circuit sets a privacy level based on an elapsed time from generation of the data for the data generated by the vehicle-mounted sensor 10, and encrypts and stores the data based on the privacy level. Similarly to the data generation section 102, these processes may be implemented by a dedicated electronic circuit, or may be implemented in a form in which information processing by software is specifically realized using hardware resources. In a case where processing is performed by software, a program or an execution file related to the software may be stored in the storage circuit.

The data storage section 200 stores data acquired and generated by the vehicle-mounted sensor 10. This data is, for example, data itself output from the vehicle-mounted sensor 10 or data encrypted at an appropriate privacy level at an appropriate timing.

For example, the following privacy level is uniquely set in the data stored in the data storage section 200. A first level is set to the data generated by the data generation section 102 at that timing. A second level is set as the privacy level of the data for which the first predetermined time has elapsed after being generated by the data generation section 102. A third level is set as the privacy level of the data for which the second predetermined time has elapsed after being generated by the data generation section 102.

This level setting may be executed by a level setting section (not illustrated), or each configuration may read the level by a time stamp stored in the storage section. Furthermore, a mode may be employed in which a different storage method is implemented for each piece of data by checking the time when the data is generated without setting the level.

The data storage section 200 stores the data generated by the data generation section 102 for the first level data.

Note that, in the above description, the privacy level is set on the basis of the time generated by the data generation section 102, but the present invention is not limited thereto, and the privacy level may be set on the basis of the time when the sensor section 100 performs sensing (for example, scanning).

The first encryption section 202 performs an encryption process using the first encryption key on the data to which the second level for which the first predetermined time has elapsed since the data was acquired is set, and stores the data in the data storage section 200. At this timing, unencrypted data is deleted from the data storage section 200. This data deletion may be executed by the first encryption section 202 or may be executed by the data control section 208.

The second encryption section 204 performs an encryption process using the second encryption key on the data to which the third level after the second predetermined time has elapsed since the data was acquired is set, and stores the data in the data storage section 200. As an example, the second encryption section 204 decrypts data with a first decryption key (The key may be the same as or different from the first encryption key.) corresponding to the first encryption key, and then encrypts the data with a second encryption key. As another example, at this timing, the first encryption section 202 or a decryption section (not illustrated) decrypts the corresponding data using the first decryption key, and the second encryption section 204 encrypts the corresponding data using the second encryption key.

At this timing, similarly to the above, the data subjected to the first encryption processing before the second encryption processing is performed by the second encryption section 204 or the data control section 208 or the decrypted data subjected to the first encryption processing is deleted from the data storage section 200.

The key storage section 206 stores a first encryption key used for encryption by the first encryption section 202 and a second encryption key used for encryption by the second encryption section 204.

Furthermore, the key storage section 206 may store the first decryption key and the second decryption key corresponding to the second encryption key together. As another form, the decryption key may be in a form that can be obtained from each encryption key, and in this case, a predetermined configuration element may also generate the decryption key at a necessary timing.

The first encryption key is, for example, a key that enables decryption by a public institution such as a police department. The first encryption section 202 encrypts the data at the second level using the key, so that the public institution can decrypt the data from the acquisition until the lapse of the second predetermined time after the lapse of the first predetermined time.

The first encryption key may be, for example, a key set at the time of factory shipment of a product including the information processing device 20 in the present disclosure.

The second encryption key is, for example, a key that enables decryption by a user such as a driver or a vehicle owner. For example, the second encryption key may be set by the user or may be generated from the biological information of the user. The second encryption section 204 encrypts the data at the third level using the key, so that only the user or only a person who has obtained permission from the user can decrypt the data after the second predetermined time has elapsed from the acquisition. The second encryption key may be, for example, a key that can be set by the user in a case where a product including the information processing device 20 in the present disclosure is used, or a key generated by acquiring biological information of the user.

In the drawing, the data storage section 200 and the key storage section 206 are illustrated as different configurations, but this is illustrated as a non-limiting example. For example, the data storage section 200 and the key storage section 206 may be mounted in a storage section (not illustrated) in the information processing device 20.

The data control section 208 discards data stored in the data storage section 200 or outputs the data to the outside via the output I/F 210. The data control section 208 can discard data stored in the data storage section 200 for which a third predetermined time longer than the second predetermined time has elapsed, for example. Furthermore, for example, the data control section 208 may discard data for which the third predetermined time has elapsed from the data storage section 200 and transmit the data to the outside via the output I/F 210. As an example, the data control section 208 can upload data after the lapse of the third predetermined time to an external server or storage.

The output I/F 210 is an interface for outputting data to the outside of the information processing device 20. The output I/F 210 may have any interface for appropriately outputting data to the outside, such as MIPI (registered trademark), USB, or a network interface.

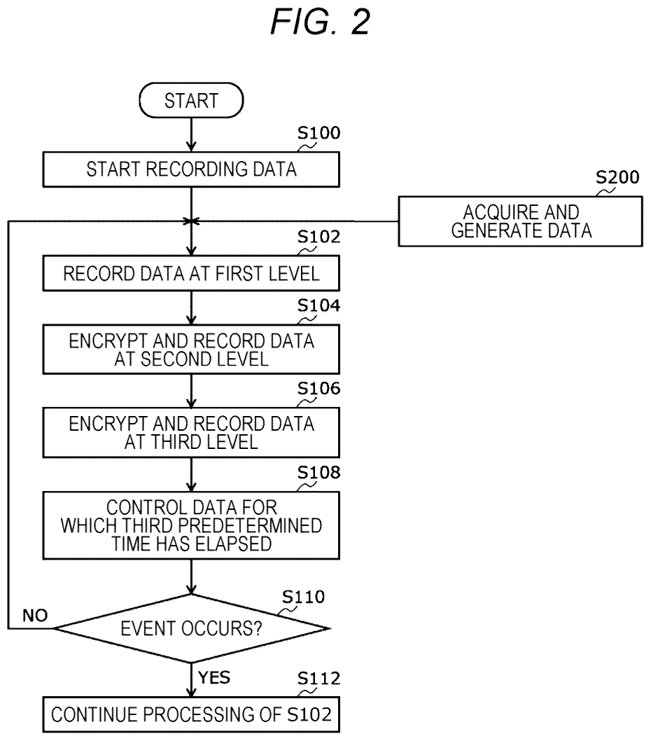

FIG. 2 is a flowchart illustrating processing of the information processing device 20 according to an embodiment. This flowchart illustrates, for example, processing for a case where an event such as a traffic accident occurs.

The occurrence of the event can be detected by, for example, various sensors provided separately from the electronic equipment 1 or including the vehicle-mounted sensor 10. The sensor may be, for example, a sensor such as an acceleration sensor, a torque sensor, or a gyro sensor. The electronic equipment 1 may acquire data from these sensors via, for example, a controller area network (CAN) or the like to acquire the event information. Furthermore, at least one of these sensors may be provided in the electronic equipment 1.

The information processing device 20 starts recording data (S100). From the data input thereafter, appropriate encryption and data storage processing are executed.

The vehicle-mounted sensor 10 acquires data by sensing, converts the data into an appropriate format, and generates data to be recorded (S200).

For the data for which the first level until the first predetermined time elapses from the data acquisition or the data generation is set, the information processing device 20 stores the data acquired from the vehicle-mounted sensor 10 in the data storage section 200 without encrypting the data (S102).

The first encryption section 202 encrypts the data for which the second level is set until the second predetermined time elapses after the first predetermined time elapses from the data acquisition or the data generation using the first encryption key and stores the encrypted data in the data storage section 200 (S104).

For example, the first encryption section 202 extracts data that is stored in the data storage section 200 without being encrypted and for which the second level is set, and encrypts the data using the first encryption key. After the encryption, for example, the data control section 208 may discard the unencrypted data from the data storage section 200.

The second encryption section 204 encrypts the data for which the third level is set until the third predetermined time elapses after the second predetermined time elapses from the data acquisition or the data generation using the second encryption key and stores the encrypted data in the data storage section 200 (S106). For example, the second encryption section 204 extracts data that is stored in the data storage section 200 without being encrypted using the second encryption key and for which the third level is set, and encrypts the data using the second encryption key. At this timing, since the data is encrypted with the first encryption key, the data encrypted with the first encryption key may be decrypted and encrypted with the second encryption key. As another example, data encrypted with the first encryption key may be further encrypted with the second encryption key.

For data for which the third predetermined time has elapsed since data acquisition or data generation, the data control section 208 may transmit the data to the outside and/or discard the data from the data storage section 200 (S108).

In a case where no event occurs (S110: NO), the information processing device 20 repeats the processing from S102 to S108. By this repetition, the information processing device 20 can record data without encryption until a first predetermined time after acquiring or generating the data, record the data from the first predetermined time to the second predetermined time by first encryption, record the data from the second predetermined time to the third predetermined time by second encryption, and discard the data for which the time has elapsed from the third predetermined time in order to secure the capacity. Note that, in a case where the capacity of the data storage section 200 becomes insufficient, for example, the processing in S102 may be stopped, or in a case where the output I/F 210 functions normally, data may be sequentially transferred from old data to an external server or the like.

In a case where an event has occurred (S110: YES), the information processing device 20 continues the processing of $102 and stops other processing (S112). By performing the processing in this manner, while data after the data of the first predetermined time before the occurrence of an event, for example, a traffic accident is set to be accessible by anyone for accident verification or the like, data before the first predetermined time before the occurrence of the accident can be decrypted by a public institution while protecting privacy. Moreover, data before the second predetermined time that is before the time that can be decrypted by the public institution can be stored in the data storage section 200 as data to be referred to with the permission of the user.

The first predetermined time, the second predetermined time, and the third predetermined time can be arbitrarily determined. For example, the first predetermined time may be set to 10 seconds, the second predetermined time may be set to 30 seconds, and the third predetermined time may be set to 3 minutes. Of course, these are given as non-limiting examples, and setting a shorter time or a longer time is not excluded.

Note that S102 to S108 may be processed in parallel. Furthermore, the timing of S110 is not limited to the flowchart, and may be operated as exception processing.

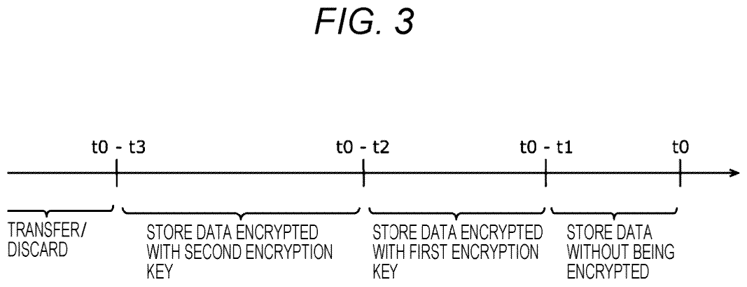

FIG. 3 is a diagram illustrating an example of data to be stored according to the flowchart. The current time t0, the first predetermined time t1, the second predetermined time t2, and the third predetermined time t3 are assumed.

Data acquired between time t0-t1 and time t0, which is data before the first predetermined time elapses, is stored without being encrypted. Data acquired between time t0-t2 and time t0-t1, which is data before the second predetermined time elapses after the first predetermined time elapses, is encrypted with the first encryption key and stored. Data acquired between the time t0-t3 and the time t0-t2, which is data before the third predetermined time elapses after the second predetermined time elapses, is encrypted with the second encryption key and stored. Data acquired before time t0-t3, which is data after the lapse of the third predetermined time, is transferred from the data storage section 200 in a state of being encrypted by the second encryption key and/or discarded.

When an event such as a traffic accident occurs at time to, data before to is stored in the data storage section 200 in this state, and on the other hand, newly acquired data is continuously stored in the data storage section 200 without being encrypted.

Here, the data may be, for example, data including image data and audio data, or may be either image data or audio data. This data may be, for example, data for one or a plurality of frames.

For example, in a case where the data is image data, the encryption may be sequentially performed according to the level set by the lapse of the predetermined time in the image for each frame. As another example, for each piece of image data of a plurality of frames, for example, the frame-by-frame encryption may be sequentially executed according to a level set by the head or tail of the plurality of frames or data of a predetermined frame number arbitrarily set exceeding a predetermined time. The similarity applies to audio data or a combination of image data and audio data.

That is, the size of the block of data to be encrypted can be arbitrarily set. However, for example, a data group exceeding the first predetermined time has little meaning in the present disclosure, and thus it is desirable that the data group has a size smaller than that of the data group that can be acquired in the first predetermined time. Similarly, it is desirable to encrypt data in units of a size smaller than a size of a data group acquired during (second predetermined time)—(first predetermined time) and (third predetermined time)—(second predetermined time).

For example, in a case where the scan speed of the sensor is 30fps and the first predetermined time is 10 seconds, data may be divided every 30 frames and encrypted. As another example, data may be encrypted frame by frame. In this manner, it is possible to combine the sizes of data in units arbitrarily set within an appropriate range and execute the encryption process.

As described above, according to the present embodiment, by storing the acquired data in an unencrypted state, an encrypted state with the first encryption key, and an encrypted state with the second encryption key under the condition of the elapsed time, it is possible to record data that can be freely restored by a public institution or the like as necessary for the verification of an accident in a case where an event such as an accident occurs while appropriately protecting the privacy of the user.

### Second Embodiment

In the above-described embodiment, a mode has been described as an example in which after the data at the second level encrypted with the first encryption key reaches the third level, decryption corresponding to the first encryption key is performed, and then the data is encrypted with the second encryption key and stored.

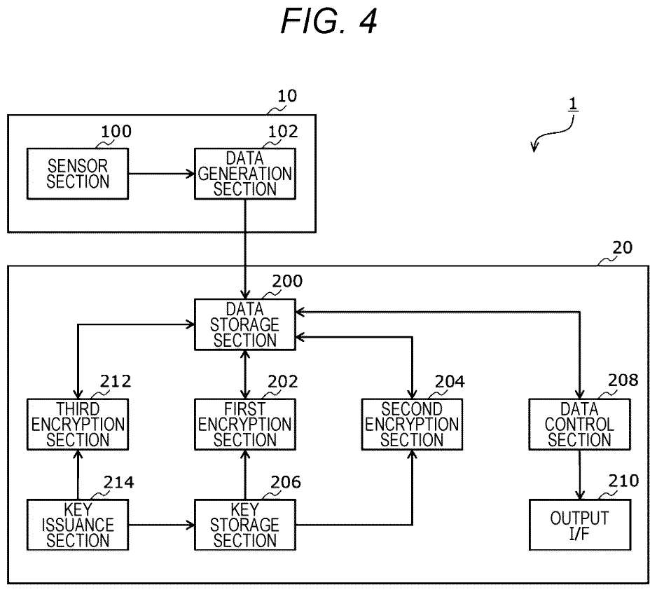

FIG. 4 is a block diagram schematically illustrating an example of the electronic equipment 1 according to an embodiment. The information processing device 20 of the electronic equipment 1 includes a third encryption section 212 and a key issuance section 214 in addition to the configuration similar to that in FIG. 1. Note that the third encryption section 212 is not an essential configuration, and for example, the first encryption section 202 may execute processing of the following third encryption section 212.

The third encryption section 212 encrypts unencrypted data stored in the data storage section 200 using the third encryption key issued by the key issuance section 214. The encryption timing may be a timing at which the data is input from the data generation section 102 to the data storage section 200, or may be a timing at which the data is set to the second level after the first predetermined time has elapsed.

The key issuance section 214 issues a third encryption key. For example, the key issuance section 214 issues a third encryption key at every predetermined timing and updates the third encryption key. The predetermined timing may be, for example, a timing at which the encryption of the data serving as the unit of encryption is completed in the above-described embodiment, or may be every predetermined time.

After the data at the second level is encrypted by the third encryption section 212, the first encryption section 202 encrypts the third encryption key using the first encryption key. The second encryption section 204 encrypts the third encryption key for the third level data using the second encryption key. Each of the first encryption section 202 and the second encryption section 204 stores the encrypted data and the encrypted third encryption key in association with each other in the data storage section 200.

In the case of extracting data, it is possible to acquire the encrypted third encryption key used to encrypt the data together with the data from the data storage section 200, decrypt the third encryption key with a key corresponding to a privacy level, and decrypt the data using the decrypted third encryption key.

The data is encrypted using the third encryption key, and the first encryption section 202 and the second encryption section 204 encrypt the same third encryption key for performing the encryption with the first encryption key and the second encryption key at the timing when the data transitions to the second level and the third level, respectively.

The third encryption key may be stored in the key storage section 206 until the encryption of the third encryption key using the second encryption key is completed. As another example, the third encryption key encrypted with the first encryption key may be decrypted at a timing when the third encryption key is encrypted with the second encryption key, and the second encryption section 204 may encrypt the decrypted third encryption key using the second encryption key.

In the former case, a memory area for storing the third encryption key is required, and there is a possibility that the third encryption key remains in the memory area in a case where the information processing device 20 fails due to an event or the like. However, it is possible to reduce temporal and computational costs at the timing of performing encryption using the second encryption key. Therefore, it is desirable to have a configuration in which the third encryption key is automatically deleted from the memory in a case where the information processing device 20 fails, for example, to use a volatile memory, or to have a configuration in which the third encryption key is deleted from the memory at the time of failure or the like.

In the latter case, while the cost of decrypting the third encryption key encrypted with the first encryption key occurs at the timing of encryption using the second encryption key, the memory cost can be reduced, and the event that can be a weak point of the security can be avoided.

As described above, the data stored in the data storage section 200 is encrypted with the third encryption key. For this reason, when the same third encryption key is used for a long time, there is a possibility that the data of the third level can be decrypted using the decryption key that can only be seen at the second level.

Therefore, the key issuance section 214 updates the third encryption key at a predetermined timing as described above. For example, in a case where the first predetermined time is 10 seconds or the like, the key issuance section 214 may update the third encryption key in a span such as every 1 second, or may update the third encryption key every time data encryption of one unit is completed. The numerical values are given as examples, and they are not limited to these numerical values.

Furthermore, for example, the key issuance section 214 may issue a random key as the third encryption key.

By issuing such a third encryption key, it is possible to generate the third encryption key capable of appropriately protecting privacy.

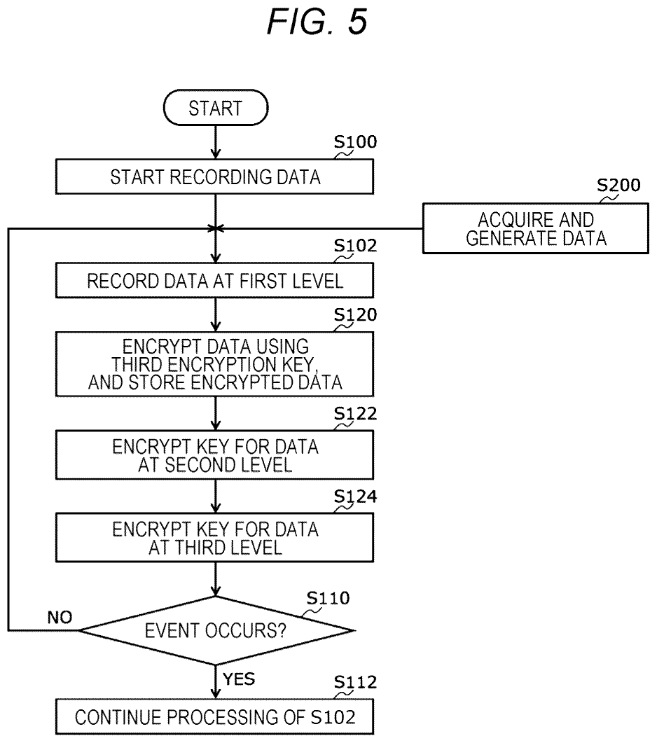

FIG. 5 is a flowchart illustrating processing of the information processing device 20 according to an embodiment. The same reference signs as those in FIG. 2 basically indicate the same processing, and thus a detailed description thereof will be omitted.

The third encryption section 202 encrypts the data of the second level using the third encryption key and stores the encrypted data in the data storage section 200 (S120). Note that the third encryption section 202 may encrypt the first level data with the third encryption key in advance and store the encrypted data in the data storage section 200. In this case, the data at the second level can be appropriately decrypted by associating data of an appropriate key.

For the data at the second level, the first encryption section 202 encrypts the third encryption key obtained by encrypting the data with the first encryption key, and stores the encrypted key in the data storage section 200 in association with the data (S122).

For the data at the third level, the second encryption section 204 encrypts a third encryption key obtained by encrypting the data with the second encryption key, and stores the encrypted key in the data storage section 200 in association with the data (S124). Note that, in a case where the third encryption key used for encryption is not stored in the memory until this timing, a process of acquiring the third encryption key encrypted with the first encryption key from the data storage section 200, decrypting the third encryption key, and then encrypting the third encryption key again with the second encryption key may be performed.

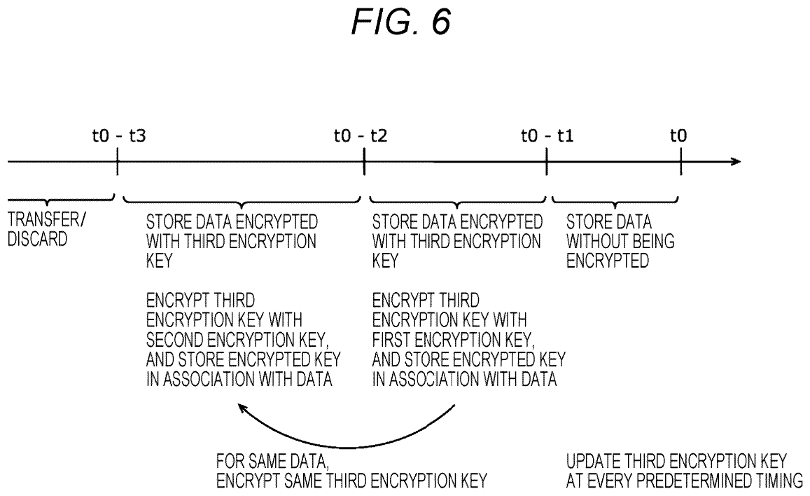

FIG. 6 is a diagram illustrating an example of stored data according to an embodiment. As illustrated in FIG. 6, in the present embodiment, the data is encrypted with the third encryption key. According to the privacy level, the third encryption keys for the encrypted data are encrypted using different keys. Then, the encrypted third encryption key is stored in association with each piece of data.

Note that, in the present embodiment, the configuration in which the third encryption key is encrypted with the first encryption key or the second encryption key has been described, but the present invention is not limited thereto, and the third decryption key for decrypting data encrypted with the third encryption key may be encrypted with the first encryption key or the second encryption key.

As described above, according to the present embodiment, similarly to the first embodiment described above, it is possible to extract data regarding investigation of an accident cause as well as privacy protection as necessary, and further, it is possible to reduce a time cost and a calculation cost regarding encryption. As a result, it is possible to reduce the probability of data corruption or the like in the middle of encryption, and more appropriate data encryption and recording can be performed.

### Third Embodiment

In each of the above-described embodiments, the encryption level is shifted with the lapse of time, but the mode in the present disclosure is not limited thereto.

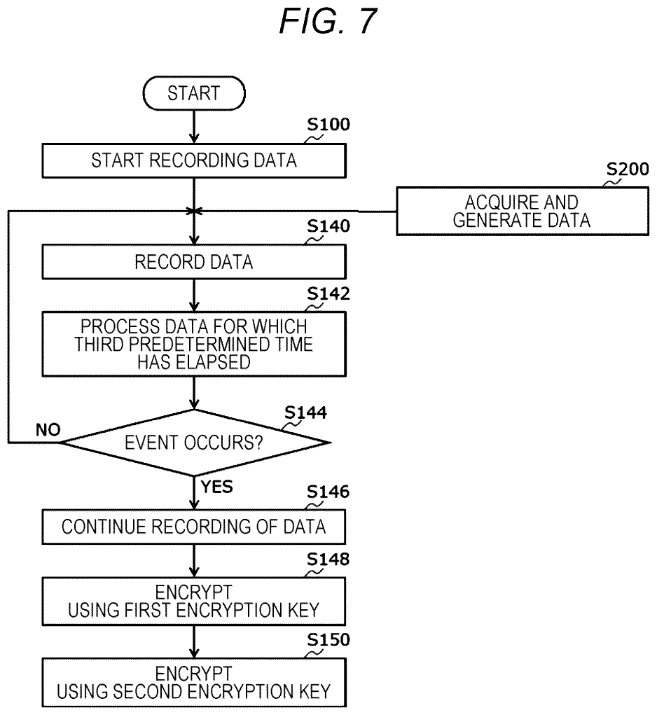

FIG. 7 is a flowchart illustrating processing of the information processing device 20 according to an embodiment. S100 and S200 are similar to those in the foregoing embodiment.

The data storage section 200 records the data output from the data generation section 102 without encrypting the data (S140).

The data control section 208 discards the data stored in the data storage section 200 and for which the third predetermined time has elapsed from the data control section 208 and/or uploads the data to an external server or the like (S142).

As described above, in the present embodiment, the data until the third predetermined time elapses is stored in the data storage section 200 without being encrypted. Note that, at this timing, for example, the data control section 208 may add a privacy level to data in the data storage section 200.

In a situation where no event occurs (S144: NO), the processes of S140 to S142 are repeatedly executed, and data for which the third predetermined time has not elapsed is continuously stored in the data storage section 200.

In a case where the event occurs (S144: YES), the data storage section 200 continues recording of the data generated by the data generation section 102 (S146). At this timing, the data control section 208 may stop uploading the data to the server or the like and erasing the data from the data storage section 200.

The first encryption section 202 encrypts the data at the second level for which the first predetermined time has elapsed since the data generation at the timing of the occurrence of the event, using the first encryption key (S148).

Similarly, the second encryption section 204 encrypts the data at third level for which the second predetermined time has elapsed since the data generation at the timing of the occurrence of the event, using the second encryption key (S150). Note that, in a case where the data for which the third predetermined time has elapsed is stored in the data storage section 200, the second encryption section 204 may also execute encryption using the second encryption key for the data for which the third predetermined time has elapsed.

As described above, according to the present embodiment, encryption according to the level may be performed at the timing when the event occurs. By performing such processing, it is possible to reduce the cost in data recording, and it is possible to allocate more resources of the information processing device 20 to other processing.

Note that, in the above description, encryption similar to the encryption in the first embodiment is used, but encryption similar to that in the second embodiment may be used. In this case, the data after the lapse of the first predetermined time may be sequentially encrypted with the third encryption key and stored in association with the third encryption key, and the decryption key for the third encryption key associated with the data encrypted at the time of occurrence of the event may be sequentially encrypted with the first encryption key or the second encryption key according to the level and stored in association with each data.

In this manner, access can be freely made as long as an event does not occur, but privacy protection may be applied at the timing when the event occurs.

### Fourth Embodiment

In each of the above-described embodiments, a privacy level is given as time elapses from data generation, but the present disclosure is not limited thereto.

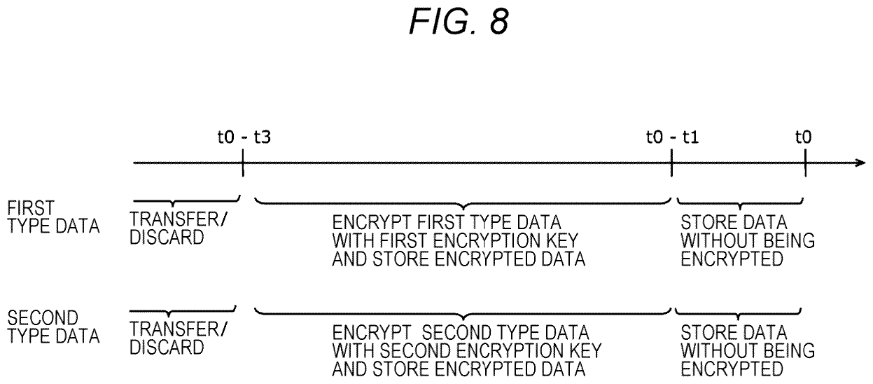

FIG. 8 is a diagram illustrating an example of storage of data according to an embodiment. As illustrated in FIG. 8, the information processing device 20 may set the level of encryption according to the type of data instead of the elapsed time from the data generation. As a non-limiting example, the first type data may be image data, and the second type data may be audio data.

The configuration of the information processing device 20 and the processing of the information processing device 20 can be similar to those of the above-described embodiments.

The information processing device 20 sets data until the first predetermined time elapses as a first level, and records the data in the data storage section 200 without encryption. In this state, the information processing device 20 sets the level of the first type data after the first predetermined time has elapsed as the second level, and sets the level of the second type data after the first predetermined time has elapsed as the third level.

After the first predetermined time has elapsed, the first encryption section 202 encrypts the data set to the second level with the first encryption key. Similarly, after the first predetermined time has elapsed, the second encryption section 204 encrypts the data set to the third level with the second encryption key. Of course, even in a mode in which the first encryption section 202 and the second encryption section 204 encrypt the third encryption key, it is possible to perform similar processing.

The data after the lapse of the third predetermined time is appropriately processed by the data control section 208.

As described above, it is also possible to set the privacy level according to the type of data. According to the present embodiment, it is possible to set the privacy level of data including a lot of information regarding privacy high, and it is possible to further strengthen privacy protection and appropriately acquire data required for accident investigation.

Note that, in each of the above-described embodiments, the encryption mainly sets whether contents of data can be browsed or not, but is not limited thereto. For example, the encryption may be encryption that prevents data falsification. Moreover, the encryption may be encryption that restricts data browsing and prevents data falsification.

Examples of encryption for avoiding the tampering include advanced encryption standard (AES), cipher-based message authentication code (CMAC), galois message authentication code (GMAC), and a technology in which only a person who knows a key can create an identifier, but are not limited thereto. Encryption that prevents data falsification may be applied to all privacy level data. By performing such processing, it is possible to prevent data falsification and improve evidence capability.

Furthermore, in each of the above-described embodiments, an example of the data to be recorded is illustrated as data regarding the vehicle acquired by the vehicle-mounted sensor 10, but the mode in the present disclosure is not limited thereto. For example, it can be used for a fixed point camera such as a monitoring camera, or can be used for a mobile terminal such as a smartphone or a tablet. Even in this case, in a case where an event occurs, it is possible to easily access the immediately preceding data, and it is possible to perform processing of encryption and tamper prevention in which a privacy level is set according to a lapse of time or a data type.

The technology according to the present disclosure can be applied to various products. For example, the technology according to the present disclosure may also be implemented as a device mounted on any kind of mobile body such as an automobile, an electric vehicle, a hybrid electric vehicle, a motorcycle, a bicycle, a personal mobility, an airplane, a drone, a vessel, a robot, a construction machine, an agricultural machine (tractor), or the like.

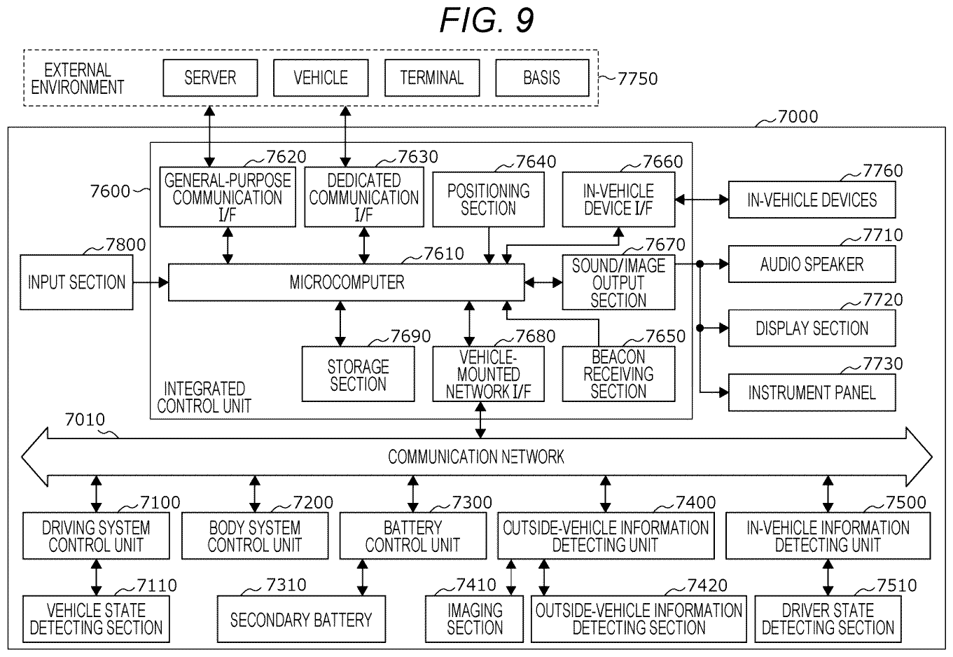

FIG. 9 is a block diagram illustrating a schematic configuration example of a vehicle control system 7000 that is an example of a moving body control system to which the technology according to the present disclosure can be applied. The vehicle control system 7000 includes a plurality of electronic control units connected to each other via a communication network 7010. In the example illustrated in FIG. 9, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 9, as a functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device).

Each of the imaging section 7410 and the outside-vehicle information detecting section 7420 may be provided as an independent sensor or device, or may be provided as a device in which a plurality of sensors or devices are integrated.

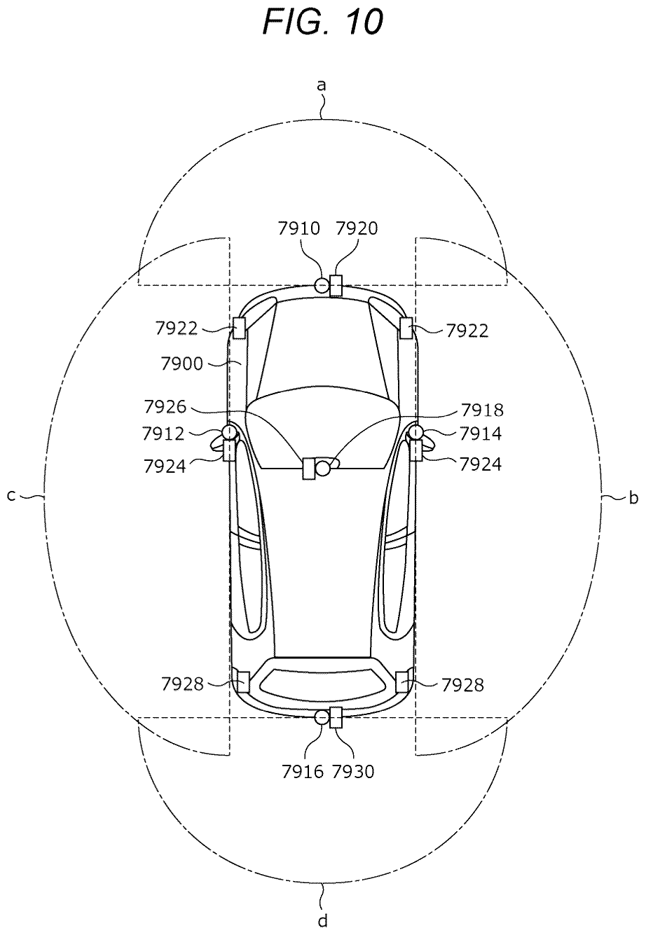

Here, FIG. 10 illustrates an example of installation positions of the imaging section 7410 and the outside-vehicle information detecting section 7420.

Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 10 illustrates an example of imaging ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 9, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave.

On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like.

The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000.

The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark) ), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010.

The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 9, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 9, at least two control units connected via the communication network 7010 may be integrated as one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for realizing each function of the information processing device 20 according to the present embodiment described with reference to FIGS. 1 to 8 can be mounted on any control unit or the like. Furthermore, a computer-readable recording medium in which such a computer program is stored can be provided. The recording medium is, for example, a magnetic disk, an optical disc, a magneto-optical disk, a flash memory, or the like. Furthermore, the computer program described above may be distributed via, for example, a network without using a recording medium.

In the vehicle control system 7000 described above, the electronic equipment 1 or the information processing device 20 according to the present embodiment described with reference to FIGS. 1 to 8 can be applied to the outside-vehicle information detecting unit 7400 or the in-vehicle information detecting unit 7500 of the application example illustrated in FIG. 9. For example, the imaging section 7410, the outside-vehicle information detecting section 7420, and/or the driver state detecting section 7510 can be implemented as a part of the vehicle-mounted sensor 10. For example, at least one configuration of the outside-vehicle information detecting unit 7400 and/or the in-vehicle information detecting unit 7500 can be at least one configuration of the information processing device 20.

The embodiments described above may have the following forms.
(1)

An information processing device including
a processing circuit that
   sets, for data generated by a sensor mounted on a vehicle, a level based on an elapsed time from generation of the data or a type of the data, and executes encryption processing of the data on the basis of the set level.
(2)

The information processing device according to (1), further including
a storage section,
in which the processing circuit stores the encrypted data in the storage section.
(3)

The information processing device according to (2), in which
the processing circuit
   sets, to a first level, the data until a first predetermined time elapses after the data is acquired, and
   stores the data at the first level in the storage section without being encrypted.
(4)

The information processing device according to (3), in which
the processing circuit
   sets, to a second level, the data until a second predetermined time elapses after the first predetermined time elapses after the data is acquired, and
   encrypts the data at the second level using a first encryption key and stores the data in the storage section.
(5)

The information processing device according to (4), in which
the processing circuit
   sets, to a third level, the data until a third predetermined time elapses after the second predetermined time elapses after the data is acquired, and
   encrypts the data at the third level using a second encryption key and stores the data in the storage section.
(6)

The information processing device according to (5), in which
the processing circuit
   performs, when the data set to the second level and encrypted is set to the third level after the second predetermined time elapses, decryption corresponding to the first encryption key and then encrypts the data using the second encryption key.
(7)

The information processing device according to (5), in which
the processing circuit
   encrypts, after the first predetermined time elapses, the data using a third encryption key, encrypts a key for decrypting the data encrypted using the third
   encryption key using the first encryption key, and stores the encrypted key in association with the data encrypted using the third encryption key, and encrypts, after the second predetermined time elapses, a key for decrypting the data encrypted using the third encryption key using the second encryption key, and stores the encrypted key in association with the data encrypted using the third encryption key.
(8)

The information processing device according to (7), in which
the processing circuit
   generates the third encryption key as a random key, and
   updates the third encryption key at every predetermined timing.
(9)

The information processing device according to any one of (5) to (8), in which
the processing circuit
   after the third predetermined time elapses from acquisition of the data, discards the data or uploads the data to an external server or storage.
(10)

The information processing device according to any one of (1) to (9), in which
the data includes one or a plurality of pieces of frame data.
(11)

The information processing device according to (10), in which
the data includes data including an image and audio.
(12)

The information processing device according to (3), in which
the processing circuit
   after the first predetermined time elapses from acquisition of the data, sets data of a first type in the data to a second level and sets data of a second type in the data to a third level,
   encrypts the data set to the second level using a first encryption key,
   encrypts the data set to the third level using a second encryption key, and
   stores each encrypted data in the storage section.
(13)

Electronic equipment including:
a vehicle-mounted sensor; and
the information processing device according to any one of (1) to (11),
in which a processing circuit of the information processing device encrypts and stores data sensed and generated by the vehicle-mounted sensor.
(14)

The electronic equipment according to (13), in which
the vehicle-mounted sensor includes an imaging section.
(15)

The electronic equipment according to (13) or (14), in which
the vehicle-mounted sensor includes a sound collection section.
(16)

An information processing method including:
by a processing circuit,
   setting, for data generated by a sensor mounted on a vehicle, a level based on an elapsed time from generation of the data; and
   executing encryption processing of the data on the basis of the set level.
(17)

A program for causing a processing circuit to execute an information processing method including:
setting, for data generated by a sensor mounted on a vehicle, a level based on an elapsed time from generation of the data; and
executing encryption processing of the data on the basis of the set level.
(18)

An information processing device including
a processing circuit that
   sets, for data generated by a sensor, a level based on an elapsed time from generation of the data or a type of the data, and
   executes encryption processing of the data on the basis of the set level.
(19)

An information processing device including:
a first encryption section that encrypts, on the basis of a first encryption key, data after a lapse of a first predetermined time from acquisition of data until a lapse of a second predetermined time;
a second encryption section that encrypts, on the basis of a second encryption key, data after a lapse of the second predetermined time from acquisition of data; and
a data storage section that stores data encrypted by the first encryption section and the second encryption section.
(20)

The information processing device according to any one of (1) to (12), the electronic equipment according to any one of (13) to (15), the information processing method according to (16), the program according to (17), or the information processing device according to (18) or (19), in which
the encryption described above includes
encryption that realizes at least one of
encryption that controls access to data or
encryption that prevents falsification of data.

Aspects of the present disclosure are not limited to the above-described embodiments, and include various conceivable modifications. The effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.
1 Electronic equipment
10 Vehicle-mounted sensor
100 Sensor section
102 Data generation section
20 Information processing device
200 Data storage section
202 First encryption section
204 Second encryption section
206 Key storage section
208 Data control section
210 Output I/F
212 Third encryption section
214 Key emission section

1. An information processing device comprising
a processing circuit that
sets, for data generated by a sensor mounted on a vehicle, a level based on an elapsed time from generation of the data or a type of the data, and
executes encryption processing of the data on a basis of the set level.

2. The information processing device according to claim 1, further comprising
a storage section,
wherein the processing circuit stores the encrypted data in the storage section.

3. The information processing device according to claim 2, wherein
the processing circuit
sets, to a first level, the data until a first predetermined time elapses after the data is acquired, and
stores the data at the first level in the storage section without being encrypted.

4. The information processing device according to claim 3, wherein
the processing circuit
sets, to a second level, the data until a second predetermined time elapses after the first predetermined time elapses after the data is acquired, and
encrypts the data at the second level using a first encryption key and stores the data in the storage section.

5. The information processing device according to claim 4, wherein
the processing circuit
sets, to a third level, the data until a third predetermined time elapses after the second predetermined time elapses after the data is acquired, and
encrypts the data at the third level using a second encryption key and stores the data in the storage section.

6. The information processing device according to claim 5, wherein
the processing circuit
performs, when the data set to the second level and encrypted is set to the third level after the second predetermined time elapses, decryption corresponding to the first encryption key and then encrypts the data using the second encryption key.

7. The information processing device according to claim 5, wherein
the processing circuit
encrypts, after the first predetermined time elapses, the data using a third encryption key, encrypts a key for decrypting the data encrypted using the third encryption key using the first encryption key, and stores the encrypted key in association with the data encrypted using the third encryption key, and
encrypts, after the second predetermined time elapses, a key for decrypting the data encrypted using the third encryption key using the second encryption key, and stores the encrypted key in association with the data encrypted using the third encryption key.

8. The information processing device according to claim 7, wherein
the processing circuit
generates the third encryption key as a random key, and
updates the third encryption key at every predetermined timing.

9. The information processing device according to claim 5, wherein
the processing circuit
after the third predetermined time elapses from acquisition of the data, discards the data or uploads the data to an external server or storage.

10. The information processing device according to claim 1, wherein the data includes one or a plurality of pieces of frame data.

11. The information processing device according to claim 10, wherein the data includes data including an image and audio.

12. The information processing device according to claim 3, wherein
the processing circuit
after the first predetermined time elapses from acquisition of the data, sets data of a first type in the data to a second level and sets data of a second type in the data to a third level,
encrypts the data set to the second level using a first encryption key,
encrypts the data set to the third level using a second encryption key, and
stores each encrypted data in the storage section.

13. Electronic equipment comprising:
a vehicle-mounted sensor; and
the information processing device according to claim 1,
wherein a processing circuit of the information processing device encrypts and stores data sensed and generated by the vehicle-mounted sensor.

14. The electronic equipment according to claim 13, wherein
the vehicle-mounted sensor includes an imaging section.

15. The electronic equipment according to claim 13, wherein
the vehicle-mounted sensor includes a sound collection section.

16. An information processing method comprising:
by a processing circuit,
setting, for data generated by a sensor mounted on a vehicle, a level based on an elapsed time from generation of the data; and
executing encryption processing of the data on a basis of the set level.

17. A program for causing a processing circuit to execute an information processing method comprising:
setting, for data generated by a sensor mounted on a vehicle, a level based on an elapsed time from generation of the data; and
executing encryption processing of the data on a basis of the set level.
